(19) United States
(12) Patent Application Publication
(10) Pub. No.: US 2007/0050732 A1
(43) Pub. Date: Mar. 1, 2007

(54) Proportional scroll bar for menu driven thermostat

(75) Inventors: John Gilman Chapman JR., Delaware, OH (US); Tony Gray, Dublin, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/215,979

(22) Filed: Aug. 31, 2005

(51) Int. Cl. G06F 17/00; B64D 13/00

(52) U.S. Cl. 715/810; 236/91 D

(57) ABSTRACT

A visual display system for use with a menu driven digital thermostat is provided. The visual display system provides a relative indication of the total number of menu items in the displayed menu on the thermostat's user interface display. A relatively sized and positioned scroll bar is utilized in one embodiment to provide such relative visual cue to a user of the position of the currently selected menu item and the total number of menu items available in the list. Directional icons may also be utilized to provide as visual cue regarding which way within the list the user is able to maneuver during operation. Both vertical and horizontal scroll bars and/or directional icons may be provided.

### FIELD OF THE INVENTION

The present invention relates generally to digital thermostats, and more particularly to digital thermostats that have a user interface display screen for programming the thermostat and display of heating, ventilating and air conditioning (HVAC) information.

### BACKGROUND OF THE INVENTION

Occupants of dwellings and commercial structures have long benefited from the inclusion of a heating, ventilating, and air conditioning (HVAC) system that regulates the temperature and humidity within the dwelling or structure. While commercial structures may include complex and expensive zone control systems, the typical dwelling, small office building or retail establishment typically have relied on a simple thermostat to regulate the temperature and humidity within those structures. Traditionally, the thermostat was a fairly simple electromechanical device that would allow a user to rotate a dial to a desired set point. The temperature sensitive switch within the thermostat would then operate to energize the heating or cooling equipment to regulate the interior temperature to the desired set point. Such traditional electromechanical thermostats, if not manually manipulated by a user, would simply regulate the interior temperature to the desired set point at all periods during the day and for all days during the week. As a result, much energy was wasted by maintaining an interior temperature at a desired level when occupants were not in the structure, such as while at work or school, or while a business is closed.

Advances in control electronics have allowed the development of new, digital thermostats that may be programmed by a user to control the heating and cooling equipment in a much more energy efficient manner. That is, modern digital thermostats allow programming that can automatically set back the heat, for example, during periods when the dwelling or structure is not occupied, and can turn up the heat just prior to and during periods of occupation of the dwelling or structure. Indeed, many such digital thermostats allow for different programming options during different days of the week, for example, one programmed operation during the week and a different programmed operation on the weekend, to accommodate the different usage patterns of the occupants of that particular dwelling or structure.

More advanced digital thermostats allow for not only programming of individual heating and cooling cycles for individual days or groups of days throughout the week, but also allow for setting of other control parameters such as service reminders, filter change reminders, programming of service contact information, etc. As the cost of the electronic processing power and memory continues to drop, additional features are likely to be added to the digital thermostats so as to provide the typical consumer or small business owner the ability to maximize comfort and energy savings by controlling all aspects of the heating and cooling of the structure or dwelling in which such a thermostat is installed.

While the advances that are being included in modern digital thermostats greatly enhance the users' comfort level and minimize the energy usage, the overall user experience interfacing with such a digital thermostat has not kept pace. That is, many such digital thermostats are menu driven devices that require a user to navigate through multiple items on a menu and through various paths in the menu tree to program all of the various features provided thereby. Unfortunately, the display screen on such digital thermostats is limited based on the physical size and aesthetic requirements of the thermostat itself. With this physical constraint on the size of the menu that can be displayed and easily read by the consumer, the displayed menu at any one time may not list all of the options that are available from that menu.

In such an existing menu driven system, it is not obvious to the user that either the end of the menu has been reached, how many more items are included in the menu before the end of the menu is reached, or even how many items are included in any one particular menu. The only information that the user knows is what is displayed on the menu screen. Unfortunately, this information may only be a subset of all of the menu items available from any particular menu in the modern digital thermostat. As such, it is not intuitive for the user to try and seek menu item options that are not displayed on the menu without reading a vast user's manual. As a result, many consumers of the modern digital thermostat may well not take advantage of several of the advanced features that may be provided by the thermostat, simply because the user is unable to tell that additional menu items are available because they are simply not displayed on the limited display area of the thermostat.

There exists, therefore, a need in the art for a display system for a digital thermostat that displays menu options in a size that may be easily read by the consumer, but that also provides an indication to the user that additional menu items are available on the menu that are not currently being displayed and where in the overall menu to current selection is.

The invention provides such a digital thermostat display system. These and other advantages of the invention, as well as additional inventive features, will be apparent from the description of the invention provided herein.

### BRIEF SUMMARY OF THE INVENTION

The present invention provides a new and improved digital thermostat. More particularly, the present invention provides a new and improved digital thermostat having a menu driven display system that provides indication to the user when additional menu items are available but not displayed. Alternatively or additionally, the present invention provides a new and improved digital thermostat having a menu driven display system that provides indication to the user where in the total list of selectable menu items the current selected item is located. Even more particularly, the present invention provides a new and improved digital thermostat that utilizes a proportional scroll bar to aid a user in navigating the menu structure used thereby. Preferably, the scroll bar height and/or width is proportional to the number of items and/or size of the particular menu so as to provide a visual cue to the user to convey both a total menu size and relative location within the menu structure. That is, the more items there are on a particular menu, the smaller the scroll bar is and the smaller the movement of the scroll bar as items on the menu are selected becomes.

In one embodiment of the present invention, a proportional scroll bar is provided along a vertical edge of the user display screen of the digital thermostat when more menu items than can be displayed are available on the current menu. In a highly preferred embodiment, such a proportional scroll bar is provided even when the displayed menu includes all of the menu items that are available to provide a consistent user experience across all menus. In a highly preferred embodiment, the size of the scroll bar and the movement thereof are proportional to the inverse of the number of items in the menu such that the user is provided with a visual cue relating their current position on the menu to the overall structure of the menu itself.

In an embodiment of the present invention wherein the menu items wrap on the display, the proportional scroll bar preferably maintains its top and bottom orientation with the first and last menu item. In other words, once the last item in the menu has been reached at the bottom of the display, a further downward movement will result in the first item of the menu being displayed below the last item of the menu. However, in a preferred embodiment the scroll bar will move to the top of the vertical orientation when this first item is selected to indicate that the user has again reached the top of the menu list, even though it would appear on the display screen as an additional item below the last item. In this way the user will not be confused into believing that the menu is an infinitely long list, the bottom of which could never be reached.

In a preferred embodiment of the present invention, a horizontal, proportional scroll bar may also be provided when the menu includes items to the right or left of the selected item on the limited thermostat display. Such a horizontal scroll bar would also preferably be proportional both in size and movement to indicate to the user where in the overall menu structure the currently selected item is and how much further to the beginning or end of that line is available.

In an alternate embodiment wherein the ability to include a vertical and/or horizontal scroll bar and still display the required information in a usable size is not available, the system of the present invention provides a right and/or left and/or an upward and/or downward facing arrow or directional icon to indicate the availability of additional menu items to the right and/or left of the currently displayed menu items. Such a display system is particularly useful when programming particular parameters of a selected menu item. In such a case the user is not so concerned with how many menu items may be available as they are with properly programming that particular menu item itself.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top view illustration of an embodiment of a thermostat constructed in accordance with the teachings of the present invention; and

FIGS. 2-12 illustrate user display screens generated by and usable with the embodiment of the thermostat of the present invention illustrated in FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

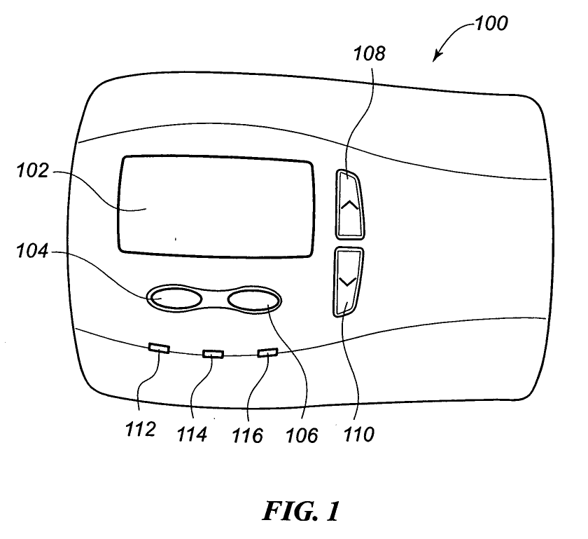

An embodiment of a thermostat constructed in accordance with the teachings of the present invention that incorporates the display system of the present invention is illustrated in FIG. 1. As with many thermostats, an internal temperature sensor is included within the thermostat 100. As may be seen from this FIG. 1, this embodiment of the thermostat 100 includes a user display 102 on which is displayed programmatic, system, and ambient information regarding the operation of the HVAC system. This user display 102 may take various forms as are well-known in the art, and in a preferred embodiment is a dot matrix LCD display. With such a display 102, the consumer may activate various programmatic and control functions via a pair of soft keys 104, 106. The functionality executed by these soft keys 104, 106 varies dependent upon the programmatic state in which the thermostat 100 is at the time one of the soft keys 104, 106 is depressed. The particular functionality that will be instituted upon selection of one of the soft keys 104, 106 is displayed in an area of the user display 102 proximate the key 104, 106 which will institute that function. That is, the function that will be instituted upon selection of soft key 104 will be located generally in the lower left hand portion of user display 102 while the functionality that will be instituted by selection of soft key 106 will be located generally in the lower right hand portion of user display 102. These functional indicators may change depending on the program state and mode in which the thermostat is currently operating.

In addition to the soft keys 104, 106, this embodiment of the thermostat 100 of the present invention also includes adjustment keys 108, 110. These adjustment keys 108, 110 may serve to adjust a currently selected parameter up or down, such as in the case of setting the control temperature at which the thermostat will maintain the ambient environment. Additionally, these keys 108, 110 may scroll through the available data for a selected parameter, such as scrolling through alphanumeric data that may be selected for a given parameter. These keys 108, 110 may also function as soft keys depending on the programmatic state in which the thermostat is operating. When this functionality is provided, the function that will be instituted by selection of key 108 will be provided generally in the upper right hand corner of display 102, while the functionality that will be instituted by selection of key 110 will be displayed generally in the lower right hand corner of user display 102. In addition to the above, other use input means, such as an alphanumeric keypad, user rotatable knob, a touch screen, etc. may be utilized instead of the buttons 104-110 illustrated in the embodiment of FIG. 1.

In this embodiment, the thermostat 100 also includes operating mode visual indicators 112, 114, 116. These indicators 112-116 provide a visual indication of the current operating mode of the thermostat. In the embodiment illustrated in FIG. 1, indicator 112 will illuminate while the thermostat 100 is operating in the cooling mode. Indicator 116 will illuminate while the thermostat 100 is operating in the heating mode. Finally, indicator 114 will illuminate to indicate that the fan is operating. Depending on the particular application, this indicator 114 may illuminate whenever the fan is running, or may illuminate only when the fan is selected to run continuously.

In embodiments of the present invention that do not utilize automated switching control between the heating and cooling modes of operation, these indicators 112-116 may operate as user selectable switches to allow the consumer to select the operating mode of the thermostat 100. For example, during the summer months the consumer may select the cooling mode by depressing indicator 112. In this mode, the furnace will not be turned on even if the interior ambient temperature drops below the setpoint. To switch from the cooling to the heating mode of operation, the consumer, in this alternate embodiment, would need to select indicator 116 to allow the thermostat 100 to operate the furnace. Consumer selection in this embodiment of indicator 114 would operate the fan continuously, as opposed to its normal automatic operation based upon a call for cooling or heat by the thermostat 100. In a still further embodiment of the present invention, the indicators 112-116 may also be utilized to provide a visual indication of system trouble, or that there is a system reminder message being displayed on user screen 102.

Having discussed the physical structure of one embodiment of a thermostat 100 constructed in accordance with the teachings of the present invention, the discussion will now focus on the user interface menu display system which forms an aspect of the present invention. Indeed, while the following discussion will utilize the structure of the thermostat 100 illustrated in FIG. 1, those skilled in the art will recognize that various other structures can be utilized without departing from the spirit and scope of the present invention. That is, regardless of the user input mechanisms utilized by the particular embodiment of the thermostat 100 of the present invention, the programmatic steps and display information provided in the following discussion may be used.

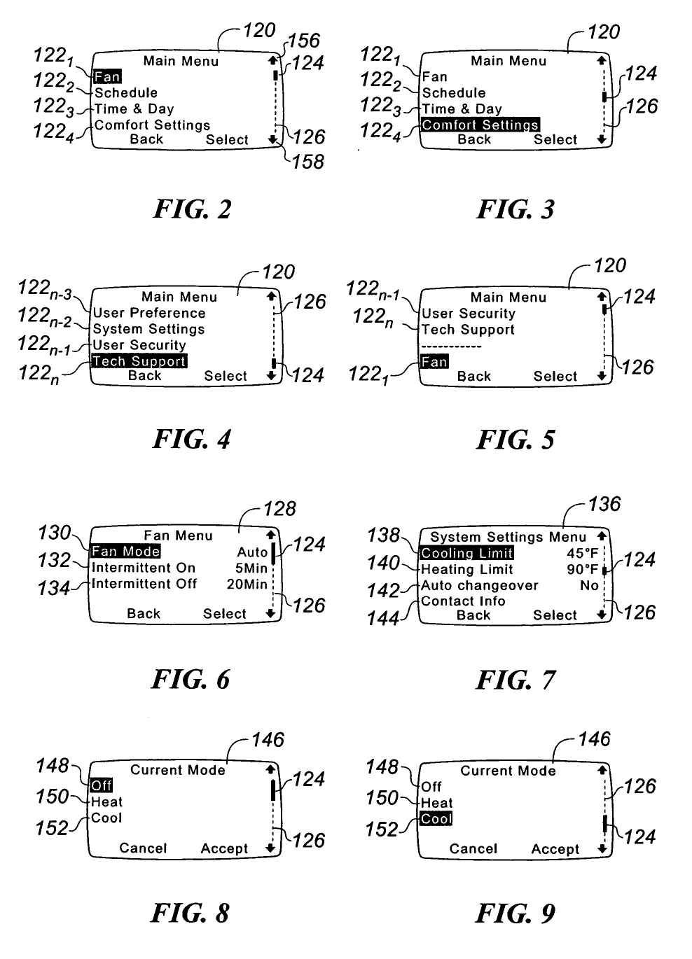

FIG. 2 illustrates an exemplary screen that may be displayed on the user interface 102 of the programmable thermostat 100 illustrated in FIG. 1. It should be noted, however, that the particular items illustrated in each of the screen shots discussed herein are provided by way of example only, and in no way limit the scope of the invention. Such particular menu screens are provided merely to illustrate the inventive features of the present invention in its various forms by illustrating exemplary menus having different number of options or items provided and arranged therein.

With this in mind, the menu 120 illustrated in FIG. 2 includes a number of individual selectable items 122₁ . . . 122ₙ. While the total number n of menu items is not known to the user, the display system of the present invention provides a visual cue, such as scroll bar 124 that is sized and positioned on a vertical track 126, to provide relative information as to the number of items 122 in the total menu, and the relative position within the total menu items of the currently selected item. Indeed, in a preferred embodiment of the present invention, the size of the scroll bar 124 will be relative to the inverse of the total size of the menu. In a highly preferred embodiment, the size of the scroll bar 124 will be approximately 1/n of the total vertical distance of the track 126, where n is the total number of items 122 in the particular menu being displayed on the user interface screen 102 of thermostat 100 (see FIG. 1). In the example illustrated in FIG. 2, the size of the scroll bar 124 is indicative of an eight item menu. At some point, however, this relationship may not hold as the total number of items on a particular menu increases to the point where its inverse would no longer be easily perceivable by the user of the thermostat display screen 102. In other words, in one embodiment to the present invention the minimum size of the scroll bar 24 is fixed to that which is easily perceivable by the user of the thermostat regardless of the number of additional menu items placed on a given menu.

As the user scrolls through the list of available menu items 122, the scroll bar 124 moves along track 126 to indicate the relative position within the total list of menu items so as to provided the user with a visual cue as to the selected items position within the overall menu which is being displayed. As illustrated in FIG. 3, the scroll bar 124 has moved approximately halfway down track 126 to indicate to the user that the selected item 122₄ is approximately halfway through the total list of menu items provided on the main menu 120 being displayed on the user interface screen 102.

Once the user has reached the end of the menu, the scroll bar 124 will have been repositioned to the bottom of track 126 to provide a visual indication to the user that the end of the available items 122ₙ in the menu has been reached. Such an indication is illustrated in FIG. 4.

In an embodiment of the present invention that utilizes a wrapping list of menu items 122, continued downward scrolling will result in the first menu item 122₁, being displayed at the bottom of screen 120 as illustrated in FIG. 5. Since this is the first item 122₁, in a list of total items 122ₙ, the scroll bar 124 of the present invention jumps to the top of track 126 to provide a visual indication to the user that the list of menu items has wrapped and that the selected item is, in fact, the first item 122₁, in the menu. Such a system precludes the otherwise likely conclusion by the user that this item 122₁, is an additional item in the list of menu items available. Such continued downward scrolling and wrapping of the menu items may otherwise lead a consumer to believe that the menu contains an unlimited list of options, the bottom of which could never be reached. By allowing the scroll bar 124 to jump to the top of track 126, this misconception is dispelled through the visual indication that the user is actually on the first menu item 122₁, in the given menu 120.

FIG. 6 illustrates a different menu 128 that includes only three menu items 130, 132, 134. For this particular menu 128, all of the available menu items 130-134 are displayed on the current display. In a preferred embodiment of the present invention, the scroll bar 124 is displayed despite the fact that all available items are displayed on the display screen 102. In this embodiment, the scroll bar 124 is resized in proportion to this such that it occupies approximately one-third of the total track length 126. As the user scrolls to the next available item on menu 128, the scroll bar 124 will move approximately one-third of the way down the track 126 to provide the user with a visual indication of the relative position in the total menu list and the total size of the list. Once the user has selected menu item 134, the scroll bar 124 will move an additional one-third of the distance on track 126 to occupy the bottom most position on track 126 so as to provide the user with a visual indication that the end of the available menu items has been reached.

FIG. 7 illustrates a different menu 136 which includes a number of menu items in addition to the four menu items 138, 140, 142 and 144 displayed on the display screen 102 of thermostat 100. While the total number of available menu items is not specifically known, the relative size of scroll bar 124 provides the user with a visual indication that there are several more menu items available both above and below the selected menu item 138 on menu 136. FIG. 7 also illustrates that regardless of which item is highlighted in the displayed subset of the total menu list of items available for the menu, the scroll bar 124 will indicate that selected item's relative position in the overall menu listing of items. This feature may become more apparent when the illustration of FIG. 3 is compared with the illustration of FIG. 7. That is, in FIG. 3 the bottom most displayed item 122₄ is highlighted, whereas the topmost item 138 in the displayed subset of items is highlighted in FIG. 7. Regardless, the scroll bar 124 still shows that highlighted item's relative position in the overall menu structure.

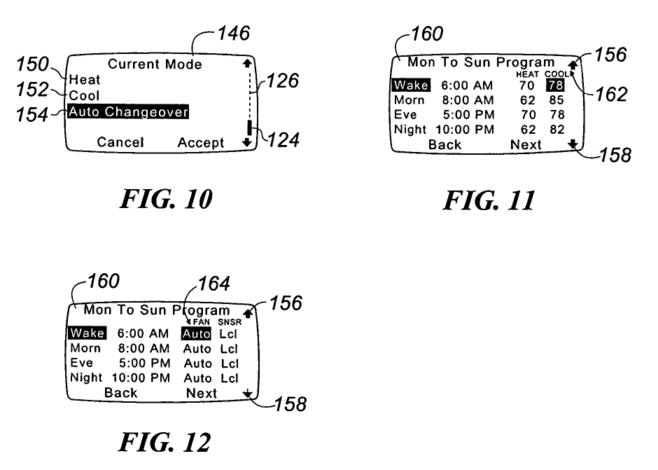

The menu 146 illustrated in FIG. 8 includes three menu items 148, 150, 152 that are displayed on the display screen 102 of thermostat 100. However, the relative size of scroll bar 124 would appear to indicate that at least an additional menu item is available through menu 146, although not displayed on the current display 102. Indeed, as the user scrolls through the list of the displayed menu 146, the bottom of the displayed items is reached as illustrated in FIG. 9. However, it is clear from the scroll bar 124 of the illustration of FIG. 9 that at least one additional menu item remains below the currently selected item 152, albeit not displayed on display 102. As the user scrolls down one additional item, the menu 146 that is displayed includes this additional menu item 154 as illustrated in FIG. 10. Additionally, the scroll bar 124 now indicates that the bottom of the current menu 146 has been reached. Indeed, the relative size of the scroll bar 124 occupies approximately one-quarter of the track length 126, and travels approximately one-quarter of the track length 126 upon each selection of the next or previous menu item such that the user is provided with a visual indication of the overall total number of menu items and the relative position within that total list of items that the currently highlighted item occupies.

While the above illustrated embodiments of the present invention utilize a vertical scroll bar to provide a visual indication of the number of items in a vertical list and the relative position of the highlighted item within that vertical list, an alternate embodiment of the present invention provides similar indication in a horizontal scroll bar when the list of menu items or available options are displayed on screen 102 in a row, as opposed to a column. Indeed, both a vertical and horizontal scroll bar are provided in a further alternate embodiment when the available items on the displayed menu are arranged in a matrix in which items may be selected by both horizontally and vertically moving within the grid.

Based on the limited real estate that is available on the user interface screen 102, it is occasionally necessary for the required programming information to occupy a majority of the screen 102. In such situations, the utilization of a scroll bar to provide the visual indication of additional available elements would actually be counter productive and distracting to the user and would result in a cluttered display that would not be pleasing or particularly helpful. As such, an alternate embodiment of the present invention utilizes directional icons 156, 158 without the scroll bar 124 or track 126 to provide the visual cue that additional menu items are available beyond the displayed sub-portion of the menu 160.

In the illustration of FIG. 11, both directional icons 156 and 158 are utilized. In addition to the vertical directional icons 156, 158, horizontal directional icons 162 and 164 (see FIG. 12) are also used to provide a visual indication to the user that additional menu items or programming items exist off screen 102. The use of the single directional icon 162 in FIG. 11 indicates to the user that additional programming inputs exist to the right of the highlighted element, while the use of directional icon 164 in FIG. 12 provides a visual indication that additional programming elements are available to the left of the highlighted or displayed elements.

While the use of only the directional icons 156, 158, 162, 164 do not provide the user with a visual indication of the number or relative position of the selected item other than in a macro sense, they do provide an elegant, simplified view that does not clutter the available real estate on display 102. Indeed, such directional icons also provide the user with a visual cue as to which scroll keys 108, 110 and/or 104, 106 may be used to select other items in the list or grid shown on the display 102 (see FIG. 1). Indeed, a preferred embodiment of the present invention, the visual cue includes both the directional icons 156, 158, 162, 164 along with the scroll bar 124 when the usage of such in combination would not clutter the display or otherwise detract from the user experience. Returning for a moment to FIG. 2, it is clear from the usage of the directional icons 156, 158 that a user could scroll up from the first item or down to move within the wrapping list of menu items on menu 120. In an embodiment that does not allow wrapping of the menu items, the illustration of FIG. 2 may dispense with the directional icon 156 since upward movement from the first item in the list would not be allowed in such an embodiment.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A digital thermostat, comprising:
a user display screen; and
a menu displayed on the user display screen, the menu including a plurality of selectable menu items arranged thereon and at least one visual cue positioned on the menu in a non-interfering location with the selectable menu items, the at least one visual cue providing context information to a user relating a currently selected menu item to the plurality of selectable menu items.

2. The thermostat of claim 1, wherein the visual cue comprises at least one scroll bar positioned on at least one a track, and wherein the position of the scroll bar on the track is related to the ordinal position of the currently selected menu item in a total number of selectable menu items on the menu.

3. The thermostat of claim 2, wherein a size of the scroll bar is related to an inverse of a total number of selectable menu items on the menu.

4. The thermostat of claim 2, wherein the scroll bar moves a distance upon selection of one of a previous menu item and a next menu item, and wherein the first distance is related to the inverse of a total number of selectable menu items on the menu times a total track length.

5. The thermostat of claim 2, wherein the plurality of selectable menu items are arranged on the menu in a column, and wherein the scroll bar and track are arranged vertically on the menu.

6. The thermostat of claim 2, wherein the plurality of selectable menu items are arranged on the menu in a row, and wherein the scroll bar and track are arranged horizontally on the menu.

7. The thermostat of claim 2, wherein the plurality of selectable menu items are arranged on the menu in matrix having rows and columns, and wherein the at least one scroll bar and the at least one track comprises a first scroll bar on a first track arranged vertically on the menu and a second scroll bar on a second track arranged horizontally on the menu.

8. The thermostat of claim 2, wherein a size of the scroll bar is inversely related to of a size of the menu.

9. The thermostat of claim 2, wherein the plurality of selectable menu items are arranged in a wrapping vertical list, and wherein the scroll bar is repositioned from a bottom of the track to a top of the track upon downward selection of a first selectable menu item after selection of a last selectable menu item in the wrapping vertical list.

10. The thermostat of claim 2, wherein the plurality of selectable menu items are arranged in a wrapping vertical list, and wherein the scroll bar is repositioned from a top of the track to a bottom of the track upon upward selection of a last selectable menu item after selection of a first selectable menu item in the wrapping vertical list.

11. The thermostat of claim 2, wherein the plurality of selectable menu items are arranged in a wrapping horizontal list, and wherein the scroll bar is repositioned from an ending of the track to a beginning of the track upon rightward selection of a first selectable menu item after selection of a last selectable menu item in the wrapping horizontal list.

12. The thermostat of claim 2, wherein the plurality of selectable menu items are arranged in a wrapping horizontal list, and wherein the scroll bar is repositioned from a beginning of the track to an ending of the track upon leftward selection of a last selectable menu item after selection of a first selectable menu item in the wrapping horizontal list.

13. The thermostat of claim 1, wherein the visual cue comprises at least one directional icon indicating location of selectable menu items that cannot be displayed on the user display screen.

14. The thermostat of claim 1, wherein the plurality of selectable menu items are arranged in a wrapping vertical list, and wherein the visual cue comprises an upward pointing directional icon and a downward pointing directional icon.

15. The thermostat of claim 1, wherein the plurality of selectable menu items are arranged in a vertical list, and wherein the visual cue comprises a downward pointing directional icon when a first selectable menu item is selected, wherein the visual cue comprises an upward pointing directional icon when a last selectable menu item is selected, and wherein the visual cue comprises the upward pointing directional icon and the downward directional icon when a currently selected menu item is neither the first nor the last menu item.

16. The thermostat of claim 1, wherein the plurality of selectable menu items are arranged in a horizontal list, and wherein the visual cue comprises a rightward pointing directional icon and a leftward pointing directional icon.

17. The thermostat of claim 1, wherein the plurality of selectable menu items are arranged on the menu in matrix having rows and columns, and wherein the visual cue comprises at least on of a rightward pointing directional icon and a leftward pointing directional icon, and at least one of an upward pointing directional icon and a downward pointing directional icon.

18. A thermostat, comprising a user display screen and a menu, the menu including a plurality of selectable items arranged in a vertical list and displayed on the user display, the menu further comprising a proportional scroll bar displayed on the user display, the proportional scroll bar being sized in an inverse relationship to a size of the vertical list and being positioned relative to a location of a currently selected menu item in the vertical list.

19. The thermostat of claim 18, wherein the menu further includes at least one additional selectable item arranged in the vertical list that is not capable of being displayed on the user display screen at the same time as all of the plurality of selectable items, and wherein the scroll bar is sized and positioned relative to the location of the currently selected menu item in the vertical list including the at least one additional selectable item.

20. The thermostat of claim 19, wherein the plurality of selectable items and the at least one additional selectable item are arranged in a vertical wrapping list, and wherein the scroll bar is repositioned from a bottom of the user display screen to a top of the user display screen upon selection of a wrapped first selectable item from selection of a last selectable item in the vertical wrapping list.
